(19) United States
(12) Patent Application Publication
(10) Pub. No.: US 2007/0286599 A1
(43) Pub. Date: Dec. 13, 2007

(54) Centralized optical-fiber-based wireless picocellular systems and methods

(76) Inventors: Michael Sauer, Corning, NY (US); Martyn N. Easton, Lenoir, NC (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/451,553

(22) Filed: Jun. 12, 2006

(51) Int. Cl. H04B 10/08

(52) U.S. Cl. 398/28; 398/103; 455/107

(57) ABSTRACT

The centralized optical-fiber-based wireless picocellular system includes one or more service units at a central head-end station. The one or more service units are optically coupled to one or more transponders via respective one or more optical fiber RF communication links. The transponders are each adapted to provide within the associated picocell electromagnetic RF service signals from different service units, and receive electromagnetic RF service signals from any client device within the picocell. The service signal from the particular client device is sent over the optical fiber RF communication link back to one or more service units. The transponders are arranged along the length of one or more optical fiber cables, which can be distributed throughout a building infrastructure. This creates a picocellular coverage area that provides a number of different wireless services relative to the building infrastructure. The service units can generate the electrical service signals, pass such signals to and from one or more outside networks, and/or coordinate the delivery of the signals between client devices within the picocellular coverage area.

### FIELD OF THE INVENTION

The present invention relates generally to wireless communication systems, and in particular relates to centralized optical-fiber-based wireless systems and methods employing radio-frequency (RF) transmission over optical fiber.

### BACKGROUND OF THE INVENTION

Wireless communication is rapidly growing, with ever-increasing demands for high-speed mobile data communication. As an example, so-called “wireless fidelity” or “WiFi” systems and wireless local area networks (WLANs) are being deployed in many different types of areas (coffee shops, airports, libraries, etc.). Wireless communication systems communicate with wireless devices called “clients,” which must reside within the wireless range or “cell coverage area” in order to communicate with the access point device.

One approach to deploying a wireless communication system involves the use of “picocells,” which are radio-frequency (RF) coverage areas having a radius in the range from about a few meters up to about 20 meters. Because a picocell covers a small area, there are typically only few users (clients) per picocell. Picocells also allow for selective wireless coverage in small regions that otherwise would have poor signal strength when covered by larger cells created by conventional base stations.

In conventional wireless systems, picocells are created by and centered on a wireless access point device connected to a head-end controller. The wireless access point device includes digital information processing electronics, an RF transmitter/receiver, and an antenna operably connected to the RF transmitter/receiver. The size of a given picocell is determined by the amount of RF power transmitted by the access point device, the receiver sensitivity, antenna gain and the RF environment, as well as by the RF transmitter/receiver sensitivity of the wireless client device. Client devices usually have a fixed RF receive sensitivity, so that the above-mentioned properties of the access point device mainly determine the picocell size. Combining a number of access point devices connected to the head-end controller creates an array of picocells that cover an area called a “picocellular coverage area.” A closely packed picocellular array provides high per-user data-throughput over the picocellular coverage area.

Prior art wireless systems and networks are wire-based signal distribution systems where the access point devices are treated as separate processing units linked to a central location. This makes the wireless system/network relatively complex and difficult to scale, particularly when many picocells need to cover a large region. Further, the digital information processing performed at the access point devices requires that these devices be activated and controlled by the head-end controller, which further complicates the distribution and use of numerous access point devices to produce a large picocellular coverage area.

### SUMMARY OF THE INVENTION

An aspect of the invention is a centralized optical-fiber-based wireless picocellular system for wirelessly communicating with one or more client devices. The system includes a plurality of service units arranged at a central location such as a central head-end station. The central location includes a plurality of electrical-to-optical (E/O) converters and optical-to-electrical (O/E) converters that are electrically coupled to the service units via respective one or more downlink multiplexers and one or more uplink multiplexers. The system also includes multiple transponders, with each transponder optically coupled to one E/O converter and one O/E converter at the central location via respective downlink and uplink optical fibers. Each transponder forms a picocell that places one, some or all of the service units in radio-frequency (RF) communication with the one or more client devices within a given picocell via the corresponding downlink and uplink optical fibers.

Another aspect of the invention is a centralized optical-fiber-based wireless picocellular system for wirelessly communicating with one or more client devices. The system includes a centralized head-end station having one or more service units. The system also includes one or more transponders each adapted to convert optical RF service signals to electromagnetic RF service signals and vice versa over a picocell formed by the corresponding transponder. The system has one or more optical fiber RF communication links that optically couple the one or more transponders to each of the one or more service units. The one or more service units send service signals to the one or more transponders over one or more of the optical fiber RF communication links. This causes the one or more transponders to transmit and receive electromagnetic service signals, and relay service signals emitted by the one or more client devices within a given picocell back to one, some or all the one or more service units over the corresponding one or more optical fiber RF communication links.

Another aspect of the invention is an optical-fiber-based wireless picocellular method of communicating with one or more client devices. The method includes sending service signals from one or more service units in a central head-end station to one or more transponders over corresponding one or more optical fiber RF communication links in order to transmit service signals over corresponding one or more picocells formed by the one or more transponders. The method also includes detecting in one or more of the transponders electromagnetic service signals emitted within each corresponding picocell by any client devices therein. The method further includes transmitting the received service signals to one or more of the service units over the corresponding one or more optical fiber RF communication links. The sending of the service signals from a service unit may include passing through such signals from an outside network, or directing such signals from another client device in the system's picocell coverage area.

Additional features and advantages of the invention are set forth in the detailed description that follows, and will be readily apparent to those skilled in the art from that description or recognized by practicing the invention as described herein, including the detailed description that follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

Accordingly, various basic electronic circuit elements and signal-conditioning components, such as bias tees, RF filters, amplifiers, power dividers, etc., are not all shown in the Figures for ease of explanation and illustration. The application of such basic electronic circuit elements and components to the systems of the present invention will be apparent to one skilled in the art.

### BRIEF DESCRIPTION OF THE DRAWINGS

FIG. 1 is a schematic diagram of a generalized embodiment of an optical-fiber-based wireless picocellular system according to the present invention showing a head-end unit optically coupled to a transponder via an optical fiber RF communication link, along with the picocell formed by the transponder and a client device within the picocell;

FIG. 2 is a detailed schematic diagram of an example embodiment of the system of FIG. 1, showing the details of the head-end unit, the optical fiber RF communication link and the transponder;

FIG. 3 is a close-up view of an alternative example embodiment for the transponder of the wireless system of FIG. 2, wherein the transponder includes a transmitting antenna and a receiving antenna;

FIG. 4 is a schematic diagram of an example embodiment of an optical-fiber-based wireless picocellular system according to the present invention that utilizes a central head-end station and multiple transponders arranged along an optical fiber cable;

FIG. 5 is a detailed schematic diagram of an example embodiment of the central head-end station of the system of FIG. 4;

FIG. 6 is a close-up cut-away view of the optical fiber cable of the system of FIG. 4, showing two transponders, the downlink and uplink optical fibers, and the electrical power line that powers the transponders;

FIG. 7 is a close-up view of one of the transponders in the optical fiber cable, illustrating the corresponding picocell and the exchange of electromagnetic RF service signals between the transponder and client devices within the picocell;

FIG. 8 is a schematic diagram of an example embodiment of an optical-fiber-based picocellular system that includes a central head-end station and multiple optical fiber cables;

FIG. 9 is a schematic “top-down view” of the system of FIG. 8, illustrating the extended picocell coverage area created by the multiple optical fiber cables;

FIG. 10 is a cut-away view of a building infrastructure illustrating an example embodiment wherein the optical-fiber-based wireless picocellular system of the present invention is incorporated into the building infrastructure;

FIG. 11 is a schematic diagram of an example embodiment of a multi-section cable used in the system of FIG. 10 to distribute the transponders throughout the building infrastructure; and

FIG. 12 is a schematic plan view of the second floor of the building infrastructure of FIG. 10, illustrating how three optical fiber cables branch out from the multi-cable connector to create an extended picocellular coverage area for the second floor.

### DETAILED DESCRIPTION OF THE PREFERRED EMBODIMENTS

Reference is now made in detail to the present preferred embodiments of the invention, examples of which are illustrated in the accompanying drawings. Whenever possible, the same or analogous reference numbers are used throughout the drawings to refer to the same or like parts.

### I. Generalized Optical-Fiber-Based Wireless System

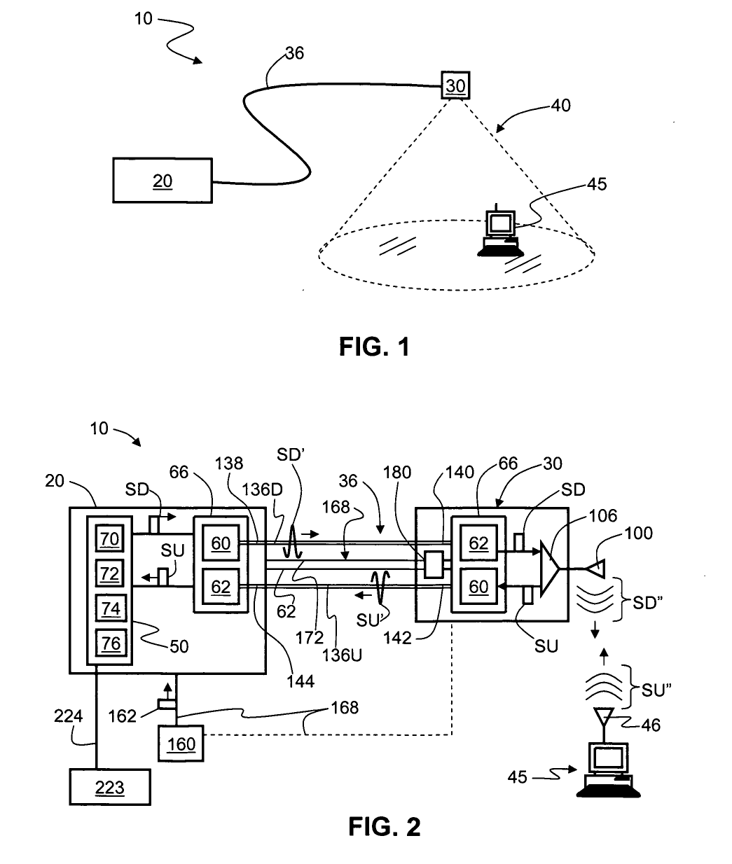

FIG. 1 is a schematic diagram of a generalized embodiment of an optical-fiber-based wireless picocellular system 10 according to the present invention. System 10 includes a head-end unit 20, a transponder unit (“transponder”) 30 and an optical fiber RF communication link 36 that optically couples the head-end unit to the transponder. As discussed in detail below, system 10 has a picocell 40 substantially centered about transponder 30. Head-end unit 20 is adapted to perform or to facilitate any one of a number of RF-over-fiber applications, such as radio-frequency identification (RFID), wireless local-area network (WLAN) communication, or cellular phone service. Shown within picocell 40 is a client device 45 in the form of a computer. Client device 45 includes an antenna 46 (e.g., a wireless card) adapted to receive and/or send electromagnetic RF signals.

FIG. 2 is a detailed schematic diagram of an example embodiment of system 10 of FIG. 1. In an example embodiment, head-end unit 20 includes a service unit 50 that provides electrical RF service signals for a particular wireless service or application. In an example embodiment, service unit 50 provides electrical RF service signals by passing (or conditioning and then passing) such signals from one or more outside networks 223, as described below. In a particular example embodiment, this includes providing WLAN signal distribution as specified in the IEEE 802.11 standard, i.e., in the frequency range from 2.4 to 2.5 GHz and from 5.0 to 6.0 GHz. In another example embodiment, service unit 50 provides electrical RF service signals by generating the signals directly. In another example embodiment, service unit 50 coordinates the delivery of the electrical RF service signals between client devices within picocellular coverage area 44.

Service unit 50 is electrically coupled to an electrical-to-optical (E/O) converter 60 that receives an electrical RF service signal from the service unit and converts it to corresponding optical signal, as discussed in greater detail below. In an example embodiment, E/O converter 60 includes a laser suitable for delivering sufficient dynamic range for the RF-over-fiber applications of the present invention, and optionally includes a laser driver/amplifier electrically coupled to the laser. Examples of suitable lasers for E/O converter 60 include laser diodes, distributed feedback (DFB) lasers, Fabry-Perot (FP) lasers, and vertical cavity surface emitting lasers (VCSELs).

Head-end unit 20 also includes an optical-to-electrical (O/E) converter 62 electrically coupled to service unit 50. O/E converter 62 receives an optical RF service signal and converts it to a corresponding electrical signal. In an example embodiment, O/E converter is a photodetector, or a photodetector electrically coupled to a linear amplifier. E/O converter 60 and O/E converter 62 constitute a “converter pair” 66.

In an example embodiment, service unit 50 includes an RF signal modulator/demodulator unit 70 for modulating/demodulating RF signals, a digital signal processing unit (“digital signal processor”) 72, a central processing unit (CPU) 74 for processing data and otherwise performing logic and computing operations, and a memory unit 76 for storing data, such as RFID tag information or data to be transmitted over the WLAN.

With continuing reference to FIG. 2, transponder 30 includes a converter pair 66, wherein the E/O converter 60 and the O/E converter 62 therein are electrically coupled to an antenna 100 via an RF signal-directing element 106, such as a circulator. Signal-directing element 106 serves to direct the downlink and uplink electrical RF service signals, as discussed below.

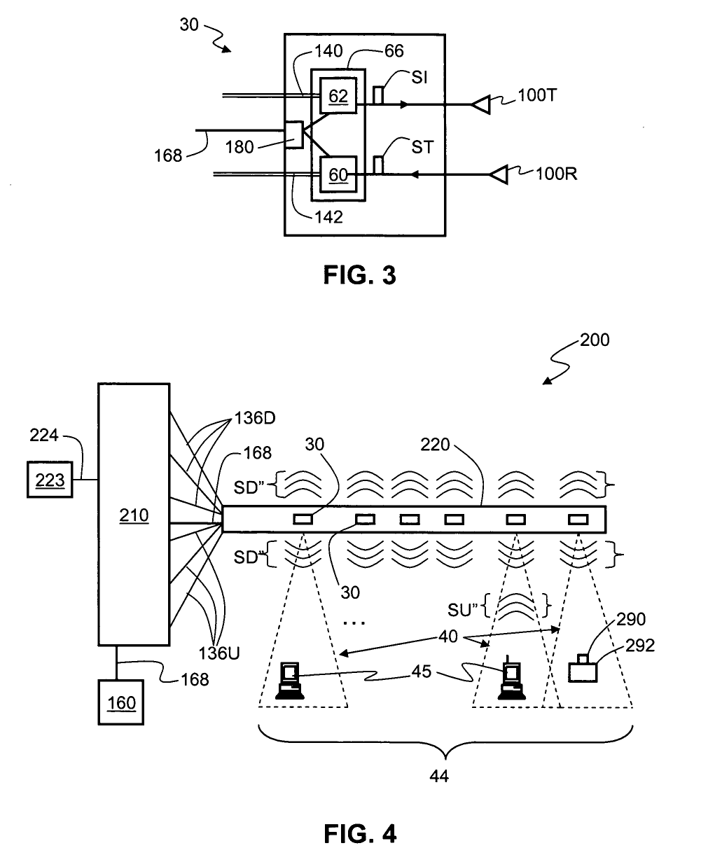

FIG. 3 is a close-up view of an alternative example embodiment for transponder 30 that includes two antennae: a transmitting antenna 100T electrically coupled to O/E converter 62, and a receiving antenna 100R electrically coupled to O/E converter 60. The two-antenna embodiment obviates the need for RF signal-directing element 106.

Transponders 30 of the present invention differ from the typical access point device associated with wireless communication systems in that the preferred embodiment of the transponder has just a few signal-conditioning elements and no digital information processing capability. Rather, the information processing capability is located remotely in head-end unit 20, and in a particular example, in service unit 50. This allows transponder 30 to be very compact and virtually maintenance free. In addition, the preferred example embodiment of transponder 30 consumes very little power, is transparent to RF signals, and does not require a local power source, as described below.

With reference again to FIG. 2, an example embodiment of optical fiber RF communication link 36 includes a downlink optical fiber 136D having an input end 138 and an output end 140, and an uplink optical fiber 136U having an input end 142 and an output end 144. The downlink and uplink optical fibers 136D and 136U optically couple converter pair 66 at head-end unit 20 to the converter pair at transponder 30. Specifically, downlink optical fiber input end 138 is optically coupled to E/O converter 60 of head-end unit 20, while output end 140 is optically coupled to O/E converter 62 at transponder 30. Similarly, uplink optical fiber input end 142 is optically coupled to E/O converter 60 of transponder 30, while output end 144 is optically coupled to O/E converter 62 at head-end unit 20.

In an example embodiment, the optical-fiber-based wireless picocellular system 10 of the present invention employs a known telecommunications wavelength, such as 850 nm, 1300 nm, or 1550 nm. In another example embodiment, system 10 employs other less common but suitable wavelengths such as 980 nm.

Example embodiments of system 10 include either single-mode optical fiber or multimode optical fiber for downlink and uplink optical fibers 136D and 136U. The particular type of optical fiber depends on the application of system 10. For many in-building deployment applications, maximum transmission distances typically do not exceed 300 meters. The maximum length for the intended RF-over-fiber transmission needs to be taken into account when considering using multi-mode optical fibers for downlink and uplink optical fibers 136D and 136U. For example, it has been shown that a 1400 MHz.km multi-mode fiber bandwidth-distance product is sufficient for 5.2 GHz transmission up to 300 m.

In an example embodiment, the present invention employs 50 μm multi-mode optical fiber for the downlink and uplink optical fibers 136D and 136U, and E/O converters 60 that operate at 850 nm using commercially available VCSELs specified for 10 Gb/s data transmission. In a more specific example embodiment, OM3 50 μm multi-mode optical fiber optical fiber is used for the downlink and uplink optical fibers 136D and 136U.

Wireless system 10 also includes a power supply 160 that generates an electrical power signal 162. Power supply 160 is electrically coupled to head-end unit 20 for powering the power-consuming elements therein. In an example embodiment, an electrical power line 168 runs through the head-end unit and over to transponder 30 to power E/O converter 60 and O/E converter 62 in converter pair 66, the optional RF signal-directing element 106 (unless element 106 is a passive device such as a circulator), and any other power-consuming elements (not shown). In an example embodiment, electrical power line 168 includes two wires 170 and 172 that carry a single voltage and that are electrically coupled to a DC power converter 180 at transponder 30. DC power converter 180 is electrically coupled to E/O converter 60 and O/E converter 62, and changes the voltage or levels of electrical power signal 162 to the power level(s) required by the power-consuming components in transponder 30. In an example embodiment, DC power converter 180 is either a DC/DC power converter, or an AC/DC power converter, depending on the type of power signal 162 carried by electrical power line 168. In an example embodiment, electrical power line 168 includes standard electrical-power-carrying electrical wire(s), e.g., 18-26 AWG (American Wire Gauge) used in standard telecommunications and other applications. In another example embodiment, electrical power line 168 (dashed line) runs directly from power supply 160 to transponder 30 rather than from or through head-end unit 20. In another example embodiment, electrical power line 168 includes more than two wires and carries multiple voltages.

In an example embodiment, head-end unit 20 is operably coupled to an outside network 223 via a network link 224.

### Method of Operation

With reference the optical-fiber-based wireless picocellular system 10 of FIG. 1 and FIG. 2, service unit 50 generates an electrical downlink RF service signal SD (“electrical signal SD”) corresponding to its particular application. In an example embodiment, this is accomplished by digital signal processor 70 providing the RF signal modulator 72 with an electrical signal (not shown) that is modulated onto an RF carrier to generate a desired electrical signal SD.

Electrical signal SD is received by E/O converter 60, which converts this electrical signal into a corresponding optical downlink RF signal SD′ (“optical signal SD′”), which is then coupled into downlink optical fiber 136D at input end 138. It is noted here that in an example embodiment optical signal SD′ is tailored to have a given modulation index. Further, in an example embodiment the modulation power of E/O converter 60 is controlled (e.g., by one or more gain-control amplifiers, not shown) to vary the transmission power from antenna 100. In an example embodiment, the amount of power provided to antenna 100 is varied to define the size of the associated picocell 40, which in example embodiments range anywhere from about a meter to about twenty meters across.

Optical signal SD′ travels over downlink optical fiber 136 to output end 140, where it is received by O/E converter 62 in transponder 30. O/E converter 62 converts optical signal SD′ back into electrical signal SD, which then travels to signal-directing element 106. Signal-directing element 106 then directs electrical signal SD to antenna 100. Electrical signal SD is fed to antenna 100, causing it to radiate a corresponding electromagnetic downlink RF signal SD″ (“electromagnetic signal SD″”).

Because client device 45 is within picocell 40, electromagnetic signal SD″ is received by client device antenna 46, which may be part of a wireless card, or a cell phone antenna, for example. Antenna 46 converts electromagnetic signal SD″ into electrical signal SD in the client device (signal SD is not shown therein). Client device 45 then processes electrical signal SD, e.g., stores the signal information in memory, displays the information as an e-mail or text message, etc.

In an example embodiment, client device 45 generates an electrical uplink RF signal SU (not shown in the client device), which is converted into an electromagnetic uplink RF signal SU″ (electromagnetic signal SU″”) by antenna 46.

Because client device 45 is located within picocell 40, electromagnetic signal SU″ is detected by transponder antenna 100, which converts this signal back into electrical signal SU. Electrical signal SU is directed by signal-directing element 106 to E/O converter 60, which converts this electrical signal into a corresponding optical uplink RF signal SU′ (“optical signal SU′”), which is then coupled into input end 142 of uplink optical fiber 136U. Optical signal SU′ travels over uplink optical fiber 136U to output end 144, where it is received by O/E converter 62 at head-end unit 20. O/E converter 62 converts optical signal SU′ back into electrical signal SU, which is then directed to service unit 50. Service unit 50 receives and processes signal SU, which in an example embodiment includes one or more of the following: storing the signal information; digitally processing or conditioning the signals; sending the signals on to one or more outside networks 223 via network links 224; and sending the signals to one or more client devices 45 in picocellular coverage area 44. In an example embodiment, the processing of signal SU includes demodulating this electrical signal in RF signal modulator/demodulator unit 70, and then processing the demodulated signal in digital signal processor 72.

### II. System with Central Head-End Station and Optical Fiber Cable

FIG. 4 is a schematic diagram of an example embodiment of an optical-fiber-based wireless picocellular system 200 that includes a central head-end station 210. Central head-end station 210 can be thought of as a modified head-end unit 20 adapted to handle multiple service units 50 and multiple transponders 30. Central head-end station 210 is optically coupled to an optical fiber cable 220 that includes multiple transponders 30. Optical fiber cable 220 is constituted by multiple optical fiber RF communication links 36, with each link optically coupled to a corresponding transponder 30. In an example embodiment, multiple transponders 30 are spaced apart along the length of optical fiber cable 220 (e.g., at 8 meter intervals) to create a desired picocell coverage area 44 made up of picocells 40, which in practice overlap at the edges.

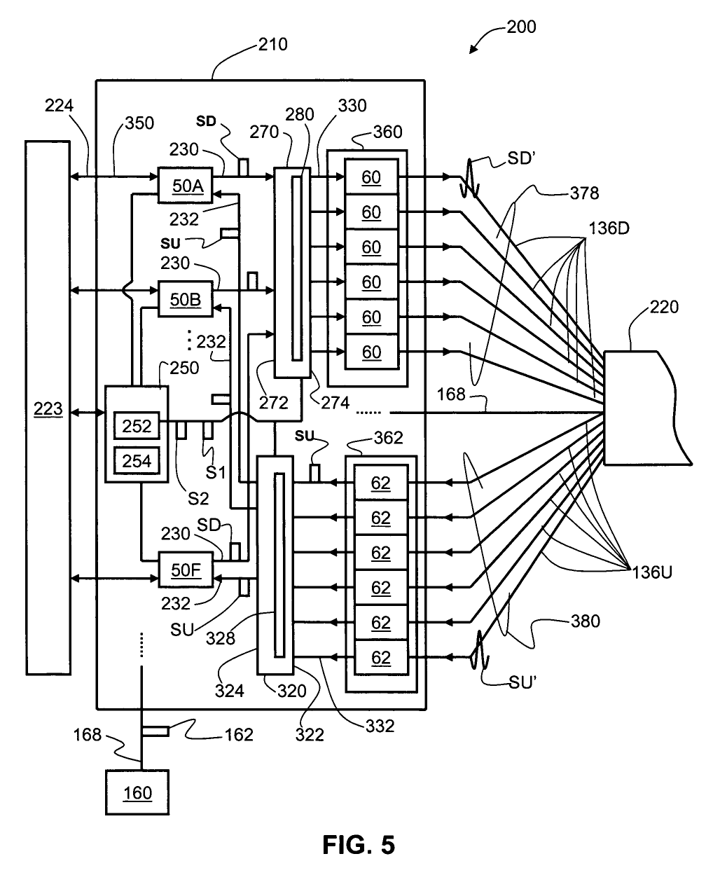

FIG. 5 is a detailed schematic diagram of an example embodiment of central head-end control station 210. Rather than including multiple head-end units 20 of FIG. 1 directly into head-end control station 210, in an example embodiment the head-end units are modified to allow for each service unit 50 to communicate with one, some, or all of transponders 30, depending on the particular application of a given service unit. Service units 50 are each electrically coupled to an RF transmission line 230 and an RF receiving line 232. In FIG. 5, three of six service units 50A through 50F are shown for the sake of illustration.

In an example embodiment, system 200 further includes a main controller 250 operably coupled to service units 50 and adapted to control and coordinate the operation of the service units in communicating with transponders 30. In an example embodiment, controller 250 includes a central processing unit (CPU) 252 and a memory unit 254 for storing data. CPU 252 is adapted (e.g., is programmed) to process information provided to controller 250 by one or more of service units 50. In an example embodiment, controller 250 is or includes a programmable computer adapted to carry out instructions (programs) provided to it or otherwise encoded therein on a computer-readable medium.

Central head-end station 210 further includes a downlink RF signal multiplexer (“downlink multiplexer”) 270 operably coupled to controller 250. Downlink multiplexer unit 270 has an input side 272 and an output side 274. Transmission lines 230 are electrically connected to downlink multiplexer 270 at input side 272.

In an example embodiment, downlink multiplexer 270 includes an RF signal-directing element 280 (e.g., an RF switch) that allows for selective communication between service units 50 and transponders 30, as described below. In an example, the selective communication involves sequentially addressing transponders 30 for polling corresponding picocells 40. Such sequential polling can be used, for example, when one of service units 50 is an RFID reader searching for RFID tags 290 in picocells 40 (FIG. 4). In an example embodiment, RFID tags 290 are attached to an item 292 to be tracked or otherwise monitored via the attached RFID tag. In another example embodiment, the selective communication involves simultaneously addressing some or all of transponders 30. Such simultaneous addressing can be used, for example, when one of service units 50 is a cellular phone transmitter or a RF-signal feed-through unit that provides simultaneous coverage of some or all of picocells 40.

Central head-end station 210 also includes an uplink RF signal multiplexer (“uplink multiplexer”) 320 operably coupled to controller 250 and having an input side 322 and an output side 324. Receiving lines 232 are electrically connected to uplink multiplexer 320 at output side 324. In an example embodiment, uplink multiplexer 320 includes an RF signal-directing element 328.

Central head-end station 210 also includes a number of E/O converters 60 that make up an E/O converter array 360, and a corresponding number of O/E converters 62 that make up an O/E converter array 362. E/O converters 60 are electrically coupled to output side 274 of downlink multiplexer 270 via electrical lines 330, and are optically coupled to input ends 138 of corresponding uplink optical fibers 36D. O/E converters 62 are electrically coupled to input side 324 of uplink multiplexer 320 via electrical lines 332, and are optically coupled to output ends 144 of corresponding uplink optical fiber 36U. Downlink optical fibers 136D constitute a downlink optical fiber cable 378 and uplink optical fibers 136U constitute an uplink optical fiber cable 380.

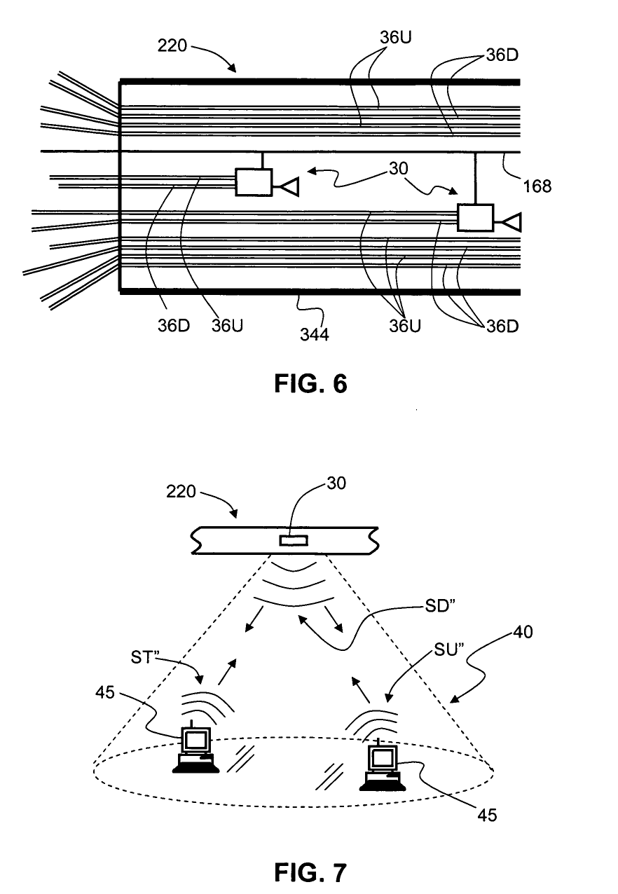

FIG. 6 is a close-up schematic diagram of optical fiber cable 220 showing downlink and uplink optical fibers 36D and 36U and two of the six transponders 30. Also shown is electrical power line 168 electrically coupled to transponders 30. In an example embodiment, optical fiber cable 220 includes a protective outer jacket 344.

### Method of Operation

With reference to FIGS. 4, 5 and 6, optical-fiber-based wireless picocellular system 200 operates as follows. At central head-end station 210, service units 50A, 50B, . . . 50F each generate or pass through from one or more outside networks 223 respective electrical signals SD that correspond to the particular application of the given service unit. Electrical signals SD are transmitted over RF transmission lines 230 to downlink multiplexer 270. Downlink multiplexer 270 then combines (in frequency) and distributes the various signals SD to E/O converters 60 in E/O converter array 360. In an example embodiment, downlink multiplexer 270 and RF signal-directing element 280 therein are controlled by controller 250 via a control signal SI to direct signals SD to one, some or all of E/O converters 60 in E/O converter array 360 and thus to one, some or all of transponders 30, based on the particular service unit application. For example, if service unit 50A is a cellular phone unit, then in an example embodiment signals SD therefrom (e.g., passing therethrough from one or more outside networks 223) are divided (and optionally amplified) equally by RF signal-directing element 280 and provided to each E/O converter 60 in E/O converter array 360. This results in each transponder 30 being addressed. On the other hand, if service unit 50F is WLAN service unit, then RF signal-directing element 280 may be adapted (e.g., programmed) to direct signals SD to select ones of E/O converters 60 in E/O converter array 360 so that only select transponders 30 are addressed.

Thus, one, some or all of E/O converters 60 in E/O converter array 360 receive electrical signals SD from downlink multiplexer 270. The addressed E/O converters 60 in E/O converter array 360 convert electrical signals SD into corresponding optical signals SD′, which are transmitted over the corresponding downlink optical fibers 136D to the corresponding transponders 30. The addressed transponders 30 convert optical signals SD′ back into electrical signals SD, which are then converted into electromagnetic signals SD″ that correspond to the particular service unit application.

FIG. 7 is a close-up view of one of transponders 30 in optical fiber cable 220, illustrating the corresponding picocell 40 and the exchange of downlink and uplink electromagnetic signals SD″ and SU″ between the transponder and client devices 44 within the picocell. In particular, electromagnetic signals SU″ are received by the corresponding transponder 30 and converted to electrical signals SU, and then to optical signals SD′. Optical signals SD′ then travel over uplink optical fiber 136U and are received by O/E converter array 362 and the corresponding O/E converters 62 therein for the addressed transponders 30. The O/E converters 60 convert optical signals SU′ back to electrical signals SU, which then proceed to uplink multiplexer 320. Uplink multiplexer 320 then distributes electrical signals SU to the service unit(s) 50 that require(s) receiving these electrical signals. The receiving service units 50 process signals SU, which in an example embodiment includes one or more of: storing the signal information; digitally processing or conditioning the signals; sending the signals on to one or more outside networks 223 via network links 224; and sending the signals to one or more client devices 45 in picocellular coverage area 44.

In an example embodiment, uplink multiplexer 320 and RF signal-directing element 328 therein are controlled by controller 250 via a control signal S2 to direct electrical signals SU to the service unit(s) 50 that require(s) receiving electrical signals SU.

In an example embodiment, the different services from some or all of service units 50 (i.e. cellular phone service, WiFi for data communication, RFID monitoring, etc.) are combined at the RF signal level by frequency multiplexing.

In an example embodiment, a single electrical power line 168 from power supply 160 at central control station 210 is incorporated into optical fiber cable 220 and is adapted to power each transponder 30, as shown in FIG. 6. Each transponder 30 taps off the needed amount of power, e.g., via DC converter 180 (FIG. 2). Since the preferred embodiment of transponder 30 has relatively low functionality and power consumption, only relatively low electrical power levels are required (e.g., ˜1 watt), allowing high-gauge wires to be used (e.g., 20 AWG or higher) for electrical power line 168. In an example embodiment that uses many transponders 30 (e.g., more than 12) in optical fiber cable 220, or if the power consumption for transponders 30 is significantly larger than 1 watt due to their particular design, lower-gauge wires or multiple wires are employed in electrical power line 168. The inevitable voltage drop along electrical power line 168 within cable 220 typically requires large-range (˜30 volts) voltage regulation at each transponder 30. In an example embodiment, DC power converters 180 at each transponder 30 perform this voltage regulation function. If the expected voltage drop is known, then in an example embodiment controller 250 carries out the voltage regulation. In an alternative embodiment, remote voltage sensing at each transponder 30 is used, but is approach is not the preferred one because it adds complexity to the system.

### III. Centralized System with Multiple Optical Fiber Cables

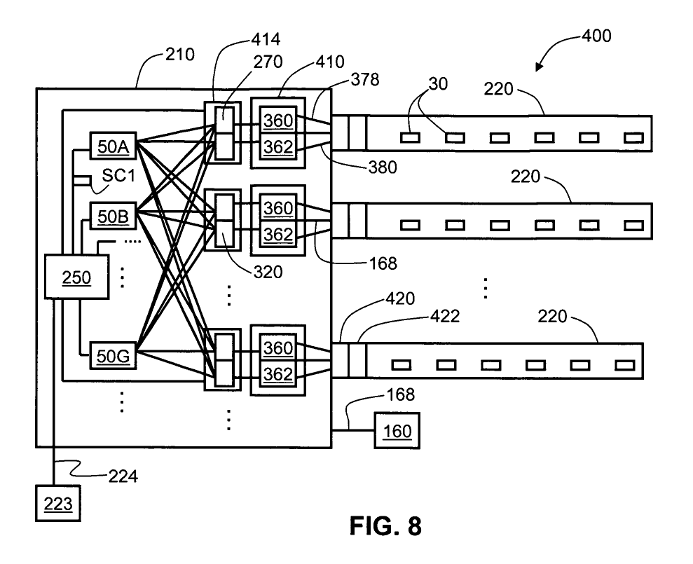

FIG. 8 is a schematic diagram of an example embodiment of a centralized optical-fiber-based wireless picocellular system 400 according the present invention. System 400 is similar to system 200 as described above, but includes multiple optical fiber cables 220 optically coupled to central head-end station 210. Central head-end station 210 includes a number of E/O converter arrays 360 and a corresponding number of O/E converter arrays 362, arranged in pairs in converter array units 410, with one converter array unit optically coupled to one optical fiber cable 220. Likewise, system 400 includes a number of downlink multiplexers 270 and uplink multiplexers 320, arranged in pairs in multiplexer units 414, with one multiplexer unit electrically coupled to one converter array unit 410. In an example embodiment, controller 250 is electrically coupled to each multiplexer unit 414 and is adapted to control the operation of the downlink and uplink multiplexers 270 and 320 therein. Here, the term “array” is not intended to be limited to components integrated onto a single chip as is often done in the art, but includes an arrangement of discrete, non-integrated components.

Each E/O converter array 360 is electrically coupled to the downlink multiplexer 270 in the corresponding multiplexer unit 414. Likewise, each O/E converter array 362 is electrically coupled to the uplink multiplexer 320 in the corresponding multiplexer unit 414. Service units 50 are each electrically coupled to both downlink and uplink multiplexers 270 and 320 within each multiplexer unit 414. Downlink and uplink optical fiber cables 378 and 380 optically couple each converter array unit 410 to a corresponding optical fiber cable 220. In an example embodiment, central head-end station 210 includes connector ports 420 and optical cables 220 include connectors 422 adapted to connect to the connector ports. In an example embodiment, connectors 422 are MT (“Mechanical Transfer”) connectors, such as the UNICAM® MTP connector available from Corning Cable Systems, Inc., Hickory, N.C. In an example embodiment, connectors 422 are adapted to accommodate electrical power line 168 connected to port 420.

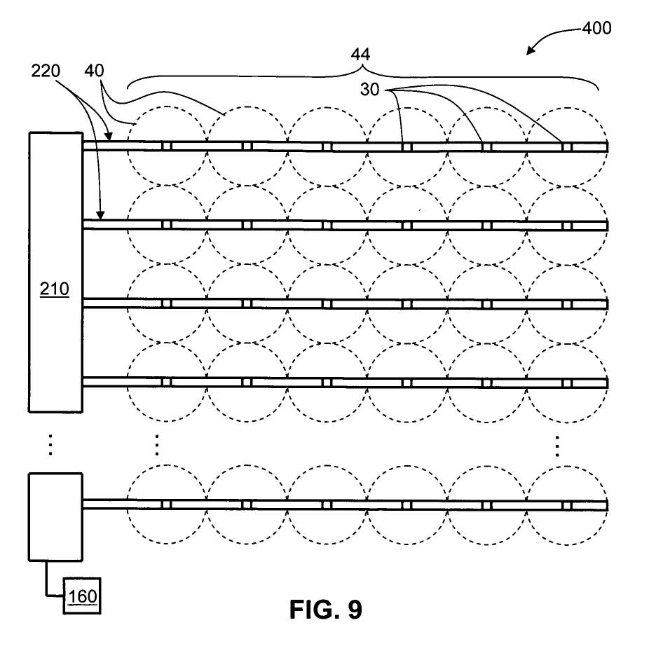

FIG. 9 is a “top down” view of system 400, showing an extended picocellular coverage area 44 formed by using multiple optical fiber cables 220. In an example embodiment, system 400 supports anywhere from two transponders 30, to hundreds of transponders, to even thousands of transponders. The particular number of transponders employed used is not fundamentally limited by the design of system 400, but rather by the particular application.

### Method of Operation

System 400 operates in a manner similar to system 200 as described above, except that instead of transponders 30 being in a single optical fiber cable 220 they are distributed over two or more optical fiber cables through the use of corresponding two or more converter array units 410. Electrical signals SD from service units 50 are distributed to each multiplexer unit 414. The downlink multiplexers 270 therein convey electrical signals SD to one, some or all of the converter array units 410, depending on which transponders are to be addresses by which service unit. Electrical signals SD are then processed as described above, with downlink optical signals SD′ being sent to one, some or all of transponders 30. Uplink optical signals SU′ generated by client devices in the corresponding picocells 40 return to the corresponding converter units 410 at central head-end station 210. The optical signals SU′ are converted to electrical signals SU at the receiving converter unit(s) 410 and are then sent to the uplink multiplexers 320 in the corresponding multiplexer unit(s) 414. Uplink multiplexers 320 therein are adapted (e.g., programmed by controller 250) to direct electrical signals SU to the service unit(s) 50 that require(s) receiving electrical signals SU. the service unit(s) 50 that require(s) receiving these electrical signals. The receiving service units 50 process signals SU, which as discussed above in an example embodiment includes one or more of: storing the signal information; digitally processing or conditioning the signals; sending the signals on to one or more outside networks 223 via network links 224; and sending the signals to one or more client devices 45 in picocellular coverage area 44.

### IV. Centralized System for a Building Infrastructure

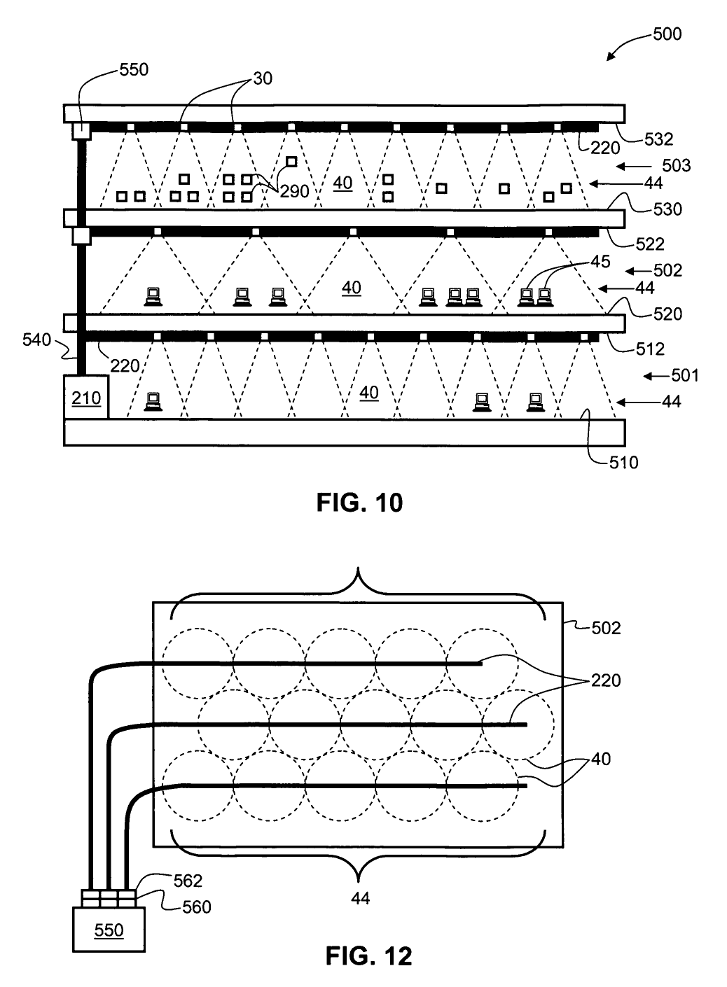

FIG. 10 is a schematic cut-away diagram of a building infrastructure 500 that generally represents any type of building in which the optical-fiber-based wireless picocellular system of the present invention would be useful, such as office buildings, schools, hospitals, college buildings, airports, warehouses, etc. Building infrastructure 500 includes a first (ground) floor 501, a second floor 502, and a third floor 503. First floor 501 is defined by a floor 510 and a ceiling 512, second floor 502 is defined by a floor 520 and a ceiling 522, and third floor 502 is defined by a floor 530 and a ceiling 532. An example centralized optical-fiber-based wireless picocellular system 400 is incorporated into building infrastructure 500 to provide a picocellular coverage area 44 that covers floors 501, 502 and 503.

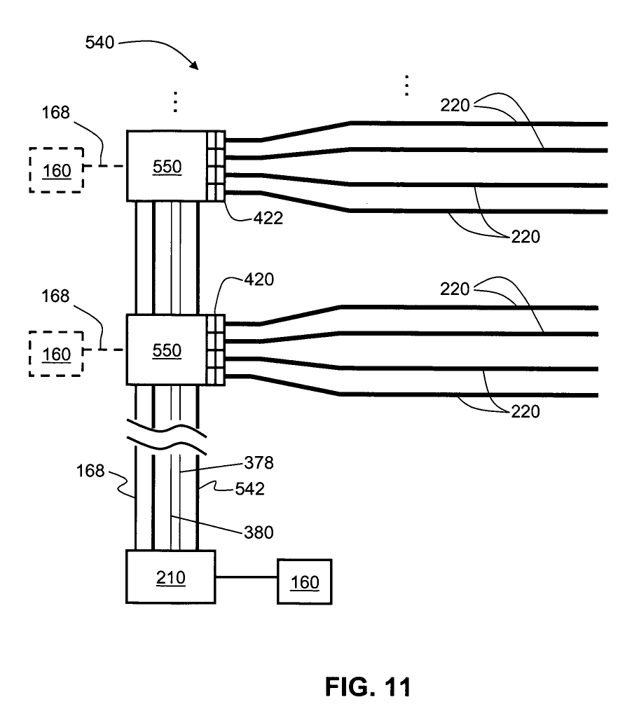

In an example embodiment, system 400 includes a main cable 540 having a number of different sections that facilitate the placement of a large number of transponders 30 in building infrastructure 500. FIG. 11 is a schematic diagram of an example embodiment of main cable 540. Cable 540 includes a riser section 542 that carries all of the uplink and downlink optical fiber cables 378 and 380 (FIG. 8) from central head-end station 210. Cabling 540 includes one or more multi-cable (MC) connectors 550 adapted to connect select downlink and uplink optical fiber cables 378 and 380, along with electrical power line 168, to a number of optical fiber cables 220. In an example embodiment, MC connectors 550 include individual optical fiber cable ports 420 and optical fiber cables 220 include matching connectors 422. In an example embodiment, riser section 542 includes a total of seventy-two downlink and seventy-two uplink optical fibers 136D and 136U, while twelve optical fiber cables 220 each carry six downlink and six uplink optical fibers.

Main cable 540 enables multiple optical fiber cables 220 to be distributed throughout building infrastructure 500 (e.g., fixed to ceilings 512, 522 and 532) to provide an extended picocellular coverage area 44 for the first, second and third floors 501, 502 and 503. An example type of an MC connector 550 is a “patch panel” used to connect incoming and outgoing optical fiber cables in an optical telecommunication system.

In an example embodiment of multi-section cabling 540, electrical power line 168 from power supply 160 runs from central head-end station 210 through riser section 542 and branches out into optical fiber cables 220 at MC connectors 550. In an alternative example embodiment, electrical power is separately supplied at each MC connector 550, as indicated by the dashed-box power supplies 160 and dashed-line electrical power lines 168.

In an example embodiment, central head-end station 210 and power supply 160 is located within building infrastructure 500 (e.g., in a closet or control room), while in another example embodiment it is located outside of the building at a remote location.

An example embodiment of the present invention involves tailoring or designing the picocell coverage areas 44 for the different floors to suit particular needs. FIG. 12 is a schematic “top down” view of the second floor 502 of building infrastructure 500, showing three optical fiber cables 220 branching out from MC connector 550 and extending over ceiling 522. Picocells 40 associated with transponders 30 (not shown in FIG. 12) form an extended picocellular coverage area 44 that covers second floor 502 with fewer, larger picocells that first and third floors 501 and 503 (FIG. 10). Such different picocell coverage areas 44 may be desirable when the different floors have different wireless needs. For example, third floor 503 might require relatively dense picocell coverage if it serves as storage for items that need to be inventoried and tracked via RFID tags 290 (FIG. 4), which in the present invention can be considered simple client devices 44. Likewise, second floor 502 may be office space that calls for larger and fewer picocells to provide cellular phone service and WLAN coverage.

### V. Advantages and Applications

### Support of Multiple Services

The systems of the present invention are transparent to the types of RF services provided by service units 50. In example embodiments, the systems provide a supported frequency band or multiple bands. Any service that can operate within the frequency band and within the designed power and dynamic range can be provided. Multiple services can be supported in either the same band or different bands. An example embodiment of the systems of the present invention support the IMS and UNTI bands, but subsets of these bands or additional frequency bands are also employable. In an example embodiment, licensed bands are supported to implement cellular signal distribution.

In an example embodiment, one or more services are added (e.g., via adding new service units 50) to the system after the first service is set up and running.

### Distributed Antenna System (DAS)

The systems of the present invention can serve as a distributed antenna system (DAS) that transmits the same signal in some or all of the picocells. This is accomplished by RF signal splitting (and amplification) at the downlink and uplink multiplexers to allow the same information to be transmitted to different transponders. In an example embodiment, this feature is applied to some services only. For example, WLAN high-speed data transmission from one service unit (or service provider) is provided to each picocell, with individual data streams to ensure high throughput rates, while a cellular DAS system is implemented at the same time by repeating a cellular signal provided by a cellular service unit (or service provider). In an example embodiment, cellular DAS is implemented in a different frequency band and runs independently of the WLAN service signal distribution.

In another example embodiment, WLAN service is initially distributed into several picocells as DAS, and when the data rate throughput requirements increase (e.g. due to increased use of the network by more and more users), the central head-end station 210 is reconfigured, e.g., via programming of controller 250 or the addition of hardware, to serve individual picocells. No modification to the transponders or optical fiber cabling hardware is needed. All frequency allocation and power settings are configured at the central head-end station. Also, upgrades to services (e.g. further developments of 802.11 standards), are run through the system without modification to the distributed hardware, with all required changes being made at the central head-end station. Different wireless service providers can be added to or removed from the system at any time.

### Picocell Size

In the present invention, the picocell size is limited mostly by RF propagation characteristics of transponders 30. The particular picocell size employed is determined by the particular application. In an example embodiment, the picocells are each sized to cover a select type of region, such as a small conference room, or a cluster of cubicles in an office space. Such picocellular coverage ensures high throughput rates for a WLAN application, for example. Note that the anticipated picocell size can be used to establish the spacing between transponders in the optical fiber cable. Picocells having a diameter smaller than about 6 meters may in some instances prove problematic due to co-channel interference issues when there are only a limited number of frequency bands available.

In an example embodiment, rather than addressing every transponder 30, the system addresses select transponders 30 (e.g., every other transponder) and boosts the power of electrical signals SD in order to create larger picocells 40 to obtain substantially the same size picocellular coverage area 44

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A centralized optical-fiber-based wireless picocellular system for wirelessly communicating with one or more client devices, comprising:
a plurality of service units arranged at a central location;
a plurality of electrical-to-optical (E/O) converters and optical-to-electrical (O/E) converters at the central location and electrically coupled to the service units via respective one or more downlink multiplexers and one or more uplink multiplexers;
multiple transponders, with each transponder optically coupled to one E/O converter and one O/E converter at the central location via respective optical fiber RF communication links; and
wherein each transponder forms a picocell that places one, some or all of the service units in radio-frequency (RF) communication with the one or more client devices within a given picocell via the corresponding optical fiber RF communication links.

2. The system of claim 1, wherein each optical fiber RF communication link includes a downlink optical fiber and an uplink optical fiber, and wherein the transponders are arranged spaced apart along one or more optical fiber cables each made up of the downlink and uplink optical fibers.

3. The system of claim 2, wherein each transponder is powered by an electrical power line that runs through each optical fiber cable.

4. The system of claim 1, wherein the service units are adapted for processing electrical RF signals, wherein the processing includes one ore more processes selected from the group of processes comprising: (a) sending and receiving information extracted from the electrical RF signals to one or more outside networks, (b) passing the electrical RF signals to and from the one or more outside networks, and (c) directing the electrical RF signals to and from client devices within one or more of the picocells.

5. The system of claim 1, wherein at least one of the service units is or includes either a wireless local-area network (WLAN) service unit, a cellular phone service unit, or a radio-frequency identification (RFID) service unit.

6. The system of claim 1, wherein the each downlink multiplexer and each uplink multiplexer includes a signal-directing element adapted to coordinate communication between the service units and the transponders.

7. The system of claim 1, wherein the transponders are incorporated into a building infrastructure such that the picocells form a picocellular coverage area relative to the building infrastructure.

8. The system of claim 7, including:
a plurality of optical fiber cables each including a number of optical fiber RF communication links, and a corresponding number of transponders; and
a main cable that includes all of the optical fiber RF communication links and one or more multi-cable connectors each adapted to optically couple to one or more of the optical fiber cables to facilitate distributing the transponders relative to the building infrastructure.

9. A centralized optical-fiber-based wireless picocellular system for wirelessly communicating with one or more client devices, comprising:
a centralized head-end station having one or more service units;
one or more transponders each adapted to convert optical RF service signals to electromagnetic RF service signals and vice versa over a picocell formed by the corresponding transponder;
one or more optical fiber RF communication links that optically couple the one or more transponders to each of the one or more service units;
wherein the one or more service units send service signals to one or more transponders over one or more of the optical fiber RF communication links to cause the one or more transponders to transmit and receive electromagnetic service signals and relay service signals emitted by the one or more client devices within a given picocell back to one or more of the service units over the corresponding one or more optical fiber RF communication links.

10. The system of claim 9, wherein each optical fiber RF communication link includes a downlink an uplink optical fiber each connected at one end to an electrical-to-optical (E/O) converter and at another end to an optical-to-electrical (O/E) converter.

11. The system of claim 9, wherein the one or more transponders is/are arranged along an optical fiber cable that includes the one or more optical fiber RF communication links.

12. The system of claim 11, wherein the optical fiber cables are arranged within a building infrastructure so as to provide a picocellular coverage area within the building infrastructure.

13. The system of claim 9, wherein the service units are selected from the group of service units comprising: a wireless network service unit, a cellular phone service unit, and a radio-frequency identification (RFID) service unit.

14. The system of claim 9, including multiplexing means for providing selective communication between the service units and the transponders.

15. An optical-fiber-based wireless picocellular method of communicating with one or more client devices, comprising.
sending service signals from at least one service unit in a central head-end station to one or more transponders over corresponding one or more optical fiber RF communication links in order to transmit the service signals over corresponding one or more picocells formed by the one or more multiple transponders;
detecting electromagnetic service signals emitted by any client devices within the one or more picocells via the transponders for those picocells; and
transmitting the received service signals to one or more service units at the central head-end station over the corresponding one or more optical fiber RF communication links.

16. The method of claim 15, including arranging some or all of the transponders spaced apart along an optical fiber cable that includes the optical fiber RF communication links for each transponder.

17. The method of claim 16, including employing a plurality of the optical fiber cables to create a picocellular coverage area that provides more than one wireless service to one, some or all of the picocells.

18. The method of claim 17, including distributing the plurality of optical fiber cables within a building infrastructure to create the picocellular coverage area relative to the building infrastructure.

19. The method of claim 16, including powering each transponder with an electrical power line within each optical fiber cable.

20. The method of claim 15, wherein sending service signals includes passing the service signals from an outside network through one or more of the service units to one or more of the plurality of transponders.
